(19) United States
(12) Patent Application Publication
(10) Pub. No.: US 2026/0025000 A1
(43) Pub. Date: Jan. 22, 2026

(54) CONTROL METHOD OF POWER SUPPLY CIRCUIT, POWER SUPPLY CIRCUIT, AND ENERGY STORAGE DEVICE

(71) Applicant: ECOFLOW INC., Shenzhen (CN)

(72) Inventors: Chao HEI, Shenzhen (CN); Dong WU, Shenzhen (CN); Xi CHEN, Shenzhen (CN); Lei WANG, Shenzhen (CN)

(21) Appl. No.: 19/342,004

(22) Filed: Sep. 26, 2025

Related U.S. Application Data
(63) Continuation of application No. PCT/CN2024/083149, filed on Mar. 22, 2024.

(30) Foreign Application Priority Data
Mar. 31, 2023 (CN) 202310369008.4

(51) Int. Cl. H02J 3/32; H02J 3/38; H02J 7/00; H02J 7/35

(52) U.S. Cl. CPC H02J 3/32; H02J 3/381; H02J 7/0063; H02J 7/00712; H02J 7/35; H02J 2300/22

(57) ABSTRACT

A control method of a power supply circuit is provided. The power supply circuit includes an AC/DC conversion circuit, a DC/DC conversion circuit, a BOOST circuit, and a BUCK/BOOST circuit that are commonly connected to a DC bus, a first device is connected to a first end of the AC/DC conversion circuit, and a DC load is connected to a second end of the BUCK/BOOST circuit. A bus voltage of the DC bus and a photovoltaic output voltage of a first photovoltaic module are obtained, and when the photovoltaic output voltage is greater than a preset input voltage, operating states of the AC/DC conversion circuit, the DC/DC conversion circuit, the BOOST circuit, and the BUCK/BOOST circuit are respectively controlled according to demand power of the first device, demand power of a battery module, demand power of a DC load, and the bus voltage.

### CROSS-REFERENCE TO RELATED APPLICATIONS

This application is a continuation application of PCT patent application No. PCT/CN2024/083149, filed on Mar. 22, 2024, which claims priority to Chinese Patent Application No. 202310369008.4 field on Mar. 31, 2023, all of which is incorporated herein by reference in their entirety.

### TECHNICAL FIELD

This application relates to the field of power supply technologies, and in particular, to a control method of a power supply circuit and an energy storage device.

### BACKGROUND

The descriptions herein only provide background information related to this application, and do not necessarily constitute an exemplary technology.

A power supply system is a system that is formed by a power source system and a power transmission and distribution system and that is configured to generate electric energy and supply and transmit the electric energy to a power consuming device. A general principle of determining the power supply system is: reliable power supply, convenient operations, safe and flexible operating, proper economy, and possibility of development.

Multi-source power supply is an indispensable technical guarantee for emergency power supply. It is well known that, switching between two or more power sources requires consistency between them, otherwise the power supply system may generate an output failure or even become paralyzed. In a conventional technology, the utility grid is typically used as a primary power source, and another power sources, such as a fuel generator, are employed as secondary power sources. During power source switching, one power source is first disconnected before the other is connected, thereby creating an interruption in power supply, which affects the ability of electrical equipment to meet requirements for high-quality power. In the related art, during use of an energy storage device connected to a plurality of power sources or connected to a plurality of loads, when a power source is powered off or has an input abnormality, the connected load may be powered off, leading to problems of poor power supply control flexibility, a low response speed, and poor user experience.

### SUMMARY

According to embodiments of this application, a control method of a power supply circuit, a power supply circuit, and an energy storage device are provided.

According to a first aspect of the embodiments of this application, a control method of a power supply circuit is provided, where the power supply circuit includes: an AC/DC conversion circuit, a DC/DC conversion circuit, a BOOST circuit, and a BUCK/BOOST circuit, where a first end of the AC/DC conversion circuit is configured to connect to a first device, a second end of the AC/DC conversion circuit is connected to a first end of the DC/DC conversion circuit through a DC bus, a second end of the DC/DC conversion circuit is configured to connect to a battery module, an input end of the BOOST circuit is configured to connect to a first photovoltaic module, an output end of the BOOST circuit and a first end of the BUCK/BOOST circuit are commonly connected to the DC bus, and a second end of the BUCK/BOOST circuit is configured to connect to a DC load; and the control method of a power supply circuit includes:
obtaining a bus voltage of the DC bus;
obtaining a photovoltaic output voltage of the first photovoltaic module;
obtaining demand power of the first device, demand power of the battery module, and demand power of the DC load; and
controlling, when the photovoltaic output voltage is greater than a preset input voltage, operating states of the AC/DC conversion circuit, the DC/DC conversion circuit, the BOOST circuit, and the BUCK/BOOST circuit respectively according to the demand power of the first device, the demand power of the battery module, the demand power of the DC load, and the bus voltage, to meet power consumption demands of the DC load, the first device, and the battery module.

According to a second aspect of the embodiments of this application, a power supply circuit is provided, where the power supply circuit includes: an AC/DC conversion circuit, a DC/DC conversion circuit, a BOOST circuit, a BUCK/BOOST circuit, and a main control circuit, where a first end of the AC/DC conversion circuit is configured to connect to a first device, a second end of the AC/DC conversion circuit is connected to a first end of the DC/DC conversion circuit through a DC bus, a second end of the DC/DC conversion circuit is configured to connect to a battery module, an input end of the BOOST circuit is configured to connect to a first photovoltaic panel, an output end of the BOOST circuit and a first end of the BUCK/BOOST circuit are commonly connected to the DC bus, a second end of the BUCK/BOOST circuit is configured to connect to a DC load, and the main control circuit is respectively connected to the AC/DC conversion circuit, the DC/DC conversion circuit, the BOOST circuit, the BUCK/BOOST circuit, and the DC bus; and

the main control circuit is configured to perform the control method according to any one of the embodiments described above.

According to a third aspect of the embodiments of this application, an energy storage device is provided, including a battery module and the power supply circuit according to the foregoing embodiments.

Details of one or more embodiments of this application are provided in the accompanying drawings and descriptions below. Other features, objectives, and advantages of this application become more apparent with reference to the specification, the accompanying drawings, and the claims

### BRIEF DESCRIPTION OF THE DRAWINGS

To describe technical solutions in embodiments of this application or the exemplary technology more clearly, the following briefly introduces accompanying drawings required for describing the embodiments or the exemplary technology. Apparently, the accompanying drawings in the following descriptions show only some embodiments of this application, and a person of ordinary skill in the art still derives accompanying drawings of other embodiments from the accompanying drawings without creative efforts.

FIG. 1 is a schematic structural diagram of a power supply circuit according to an embodiment of this application.

FIG. 2 is a flowchart of a control method of a power supply circuit according to an embodiment of this application.

FIG. 3 is a flowchart of a control method of a power supply circuit according to another embodiment of this application.

FIG. 4 is a flowchart of a control method of a power supply circuit according to another embodiment of this application.

FIG. 5 is a flowchart of a control method of a power supply circuit according to another embodiment of this application.

FIG. 6 is a flowchart of a control method of a power supply circuit according to another embodiment of this application.

FIG. 7 is a flowchart of a control method of a power supply circuit according to another embodiment of this application.

FIG. 8 is a flowchart of a control method of a power supply circuit according to another embodiment of this application.

FIG. 9 is a flowchart of a control method of a power supply circuit according to another embodiment of this application.

FIG. 10 is a flowchart of a control method of a power supply circuit according to another embodiment of this application.

FIG. 11 is a schematic structural diagram of a power supply circuit according to another embodiment of this application.

FIG. 12 is a schematic structural diagram of an energy storage device according to an embodiment of this application.

FIG. 13 is a schematic structural diagram of a battery module according to an embodiment of this application.

### DETAILED DESCRIPTION

To make the technical problems to be resolved by this application, the technical solutions, and beneficial effects more comprehensible, the following further describes this application in detail with reference to the accompanying drawings and embodiments. It should be understood that, the specific embodiments described herein are merely used for describing this application and are not intended to limit this application.

In this application, the terms “first” and “second” are used for descriptive purposes only and shall not be construed as indicating or implying relative importance or implicitly indicating a quantity of indicated technical features. Therefore, a feature defined by “first” or “second” may explicitly or implicitly include one or more of the features. In the descriptions of this application, “a plurality of” means one or more, unless otherwise definitely and specifically limited.

During use of a conventional energy storage device, a plurality of power sources and a plurality of loads may be connected. In a specific use process, due to configuration of the energy storage device, when a power source is powered off or has an input abnormality, the connected load may be powered off, leading to problems of poor power supply control flexibility, a low response speed, and poor user experience of the energy storage device.

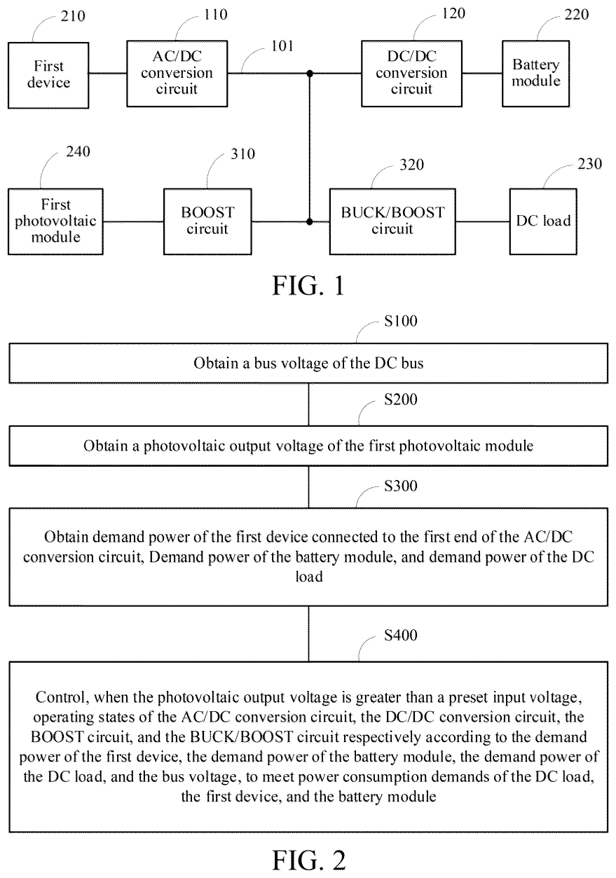

To resolve the foregoing technical problems, an embodiment of this application provides a control method of a power supply circuit. As shown in FIG. 1, the power supply circuit in this embodiment includes: an AC/DC conversion circuit 110, a DC/DC conversion circuit 120, a BOOST circuit 310, and a BUCK/BOOST circuit 320.

Specifically, a first end of the AC/DC conversion circuit 110 is configured to connect to a first device 210, and a second end of the AC/DC conversion circuit 110 is connected to a first end of the DC/DC conversion circuit 120 through a DC bus 101. A second end of the DC/DC conversion circuit 120 is configured to connect to a battery module 220. An input end of the BOOST circuit 310 is configured to connect to a first photovoltaic module 240, and an output end of the BOOST circuit 310 and a first end of the BUCK/BOOST circuit 320 are commonly connected to the DC bus 101. A second end of the BUCK/BOOST circuit 320 is configured to connect to a DC load 230.

In this embodiment, the AC/DC conversion circuit 110 may be configured to convert a direct current on the DC bus 101 into an alternating current and output the alternating current to the first device 210. The DC/DC conversion circuit 120 may be configured to perform voltage conversion on the direct current on the DC bus 101 and then charge the battery module 220. The DC/DC conversion circuit 120 may alternatively perform, according to an instruction, voltage conversion on a direct current outputted by the battery module 220 and then output the direct current to the DC bus 101. That is, the DC/DC conversion circuit 120 can control the battery module 220 to discharge. The BOOST circuit 310 is configured to boost a direct current generated by the first photovoltaic module 240, and output the boosted direct current to the DC bus 101. The BUCK/BOOST circuit 320 is further configured to draw power from the DC bus 101, and perform voltage conversion on a direct current provided by the DC bus 101 and output the direct current to the DC load 230, where the voltage conversion includes boost or buck.

In an embodiment, the DC/DC conversion circuit 120 may be a bidirectional LLC circuit.

In an embodiment, the first device 210 may be an alternating current device, for example, a three-phase motor.

In an embodiment, the first device 210 may be an AC power source, such as utility power or a three-phase power grid, or the like. The AC/DC conversion circuit 110 may be further configured to convert an alternating current provided by the first device 210 into a direct current and output the direct current to the DC bus 101.

In an embodiment, the first photovoltaic module 240 may be a photovoltaic array.

In an embodiment, a photovoltaic maximum power point tracking (MPPT) circuit is further arranged between the first photovoltaic module 240 and the input end of the BOOST circuit 310. The MPPT circuit performs, through a power conversion circuit thereof, power conversion on a voltage inputted by the photovoltaic array and then outputs the converted voltage to the input end of the BOOST circuit 310.

In an embodiment, the DC load 230 may be a direct current charging pile.

In an embodiment, an operating voltage of the direct current charging pile may range from 300 V to 750 V.

In an embodiment, a bus capacitor is arranged on the DC bus 101.

As shown in FIG. 2, the control method of a power supply circuit in this embodiment includes the following step S100 to step S400.

Step S100: Obtain a bus voltage of the DC bus 101.

Step S200: Obtain a photovoltaic output voltage of the first photovoltaic module 240.

In this embodiment, both the first photovoltaic module 240 and the battery module 220 may be used as a DC power source to supply power to the DC bus 101. A charging/discharging state of the battery module 220 may be controlled by controlling an operating state of the DC/DC conversion circuit 120. A power output of the first photovoltaic module 240 may be controlled by controlling an operating state of the BOOST circuit 310.

In this embodiment, voltage sampling may be performed on the photovoltaic output voltage of the first photovoltaic module 240 and the bus voltage on the DC bus 101 respectively by using a plurality of voltage sampling circuits.

Step S300: Obtain demand power of the first device 210 connected to the first end of the AC/DC conversion circuit 110, demand power of the battery module 220, and demand power of the DC load 230.

In this embodiment, when the first photovoltaic module 240 is used as an input power source, the first device 210, the battery module 220, and the DC load 230 may be used as power consuming loads. Output power of the first photovoltaic module 240 may be distributed by controlling operating states and operating parameters of the AC/DC conversion circuit 110, the DC/DC conversion circuit 120, the BOOST circuit 310, and the BUCK/BOOST circuit 320, to distribute the output power of the first photovoltaic module 240 to various power consuming loads. A sum of the demand power of the first device 210, the demand power of the battery module 220, and the demand power of the DC load 230 is equal to the output power of the first photovoltaic module 240.

Step S400: Control, when the photovoltaic output voltage is greater than a preset input voltage, operating states of the AC/DC conversion circuit 110, the DC/DC conversion circuit 120, the BOOST circuit 310, and the BUCK/BOOST circuit 320 respectively according to the demand power of the first device 210, the demand power of the battery module 220, the demand power of the DC load 230, and the bus voltage, to meet power consumption demands of the DC load 230, the first device 210, and the battery module 220.

In this embodiment, when the photovoltaic output voltage is greater than the preset input voltage, the BOOST circuit 310 boosts the photovoltaic output voltage of the first photovoltaic module 240 and outputs the boosted voltage to the DC bus 101. In this case, the first device 210, the battery module 220, and the DC load 230 are all used as power consuming loads. Since different power consuming loads have different demand power and the power consuming loads have different priorities, in this case, the output power of the first photovoltaic module 240 needs to be distributed based on the bus voltage on the DC bus 101. That is, the operating states of the AC/DC conversion circuit 110, the DC/DC conversion circuit 120, the BOOST circuit 310, and the BUCK/BOOST circuit 320 are controlled based on the demand power of the first device 210, the demand power of the battery module 220, the demand power of the DC load 230, and the bus voltage on the DC bus 101. Conversion power of the AC/DC conversion circuit 110, conversion power of the DC/DC conversion circuit 120, conversion power of the BOOST circuit 310, and conversion power of the BUCK/BOOST circuit 320 are controlled respectively, to meet the power consumption demands of the DC load 230, the first device 210, and the battery module 220.

In an embodiment, when the sum of the demand power of the first device 210, the demand power of the battery module 220, and the demand power of the DC load 230 is equal to or less than the output power of the first photovoltaic module 240, the AC/DC conversion circuit 110 is controlled according to the demand power of the first device 210 to convert a direct current on the DC bus 101 into an alternating current and output the alternating current to the first device 210. The DC/DC conversion circuit 120 is controlled according to the demand power of the battery module 220 to convert the direct current on the DC bus 101 into a corresponding direct current voltage to charge the battery module 220. The BUCK/BOOST circuit 320 is controlled according to the demand power of the DC load 230 to convert the direct current on the DC bus 101 into a corresponding direct current voltage and output the direct current voltage to the DC load 230. Through the foregoing control, the first photovoltaic module 240 can supply power to all the power consuming loads, the operating states of the AC/DC conversion circuit 110, the DC/DC conversion circuit 120, the BOOST circuit 310, and the BUCK/BOOST circuit 320 can be switched, and the output power of the first photovoltaic module 240 can be distributed.

In an embodiment, when the sum of the demand power of the first device 210, the demand power of the battery module 220, and the demand power of the DC load 230 is less than the output power of the first photovoltaic module 240, the BOOST circuit 310 converts the photovoltaic output voltage of the first photovoltaic module 240, so that the demand power of the first device 210, the demand power of the battery module 220, and the demand power of the DC load 230 are exactly equal to output power of the BOOST circuit 310.

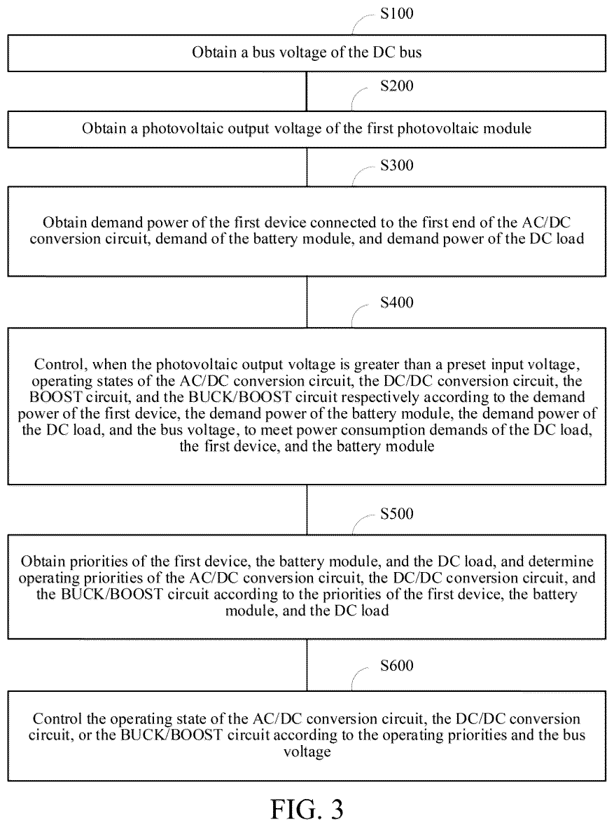

In an embodiment, as shown in FIG. 3, the control method in this embodiment further includes step S500 and step S600.

Step S500: Obtain priorities of the first device 210, the battery module 220, and the DC load 230, and determine operating priorities of the AC/DC conversion circuit 110, the DC/DC conversion circuit 120, and the BUCK/BOOST circuit 320 according to the priorities of the first device 210, the battery module 220, and the DC load 230.

In this embodiment, the bus voltage of the DC bus 101 corresponds to the output voltage of the first photovoltaic module 240. Since the power consuming loads have different demand conditions, for example, when the bus voltage of the DC bus 101 is low, power cannot be supplied to the first device 210, the battery module 220, and the DC load 230 simultaneously according to the demand power thereof. In this case, a power consumption situation of the battery module 220 is not urgent, so that the conversion power of the DC/DC conversion circuit 120 can be reduced, to preferentially meet power consumption of the first device 210 and the DC load 230. In this case, the operating priorities of the AC/DC conversion circuit 110, the DC/DC conversion circuit 120, and the BUCK/BOOST circuit 320 may be determined based on the priorities of the first device 210, the battery module 220, and the DC load 230, to distribute the output power of the first photovoltaic module 240, thereby avoiding problems of a damaged device or an incapability of meeting a demand of a connected load caused by overloading when the bus voltage of the DC bus 101 is low.

Step S600: Control the operating state of the AC/DC conversion circuit 110, the DC/DC conversion circuit 120, or the BUCK/BOOST circuit 320 according to the operating priorities and the bus voltage.

In this embodiment, the conversion power of the AC/DC conversion circuit 110, the DC/DC conversion circuit 120, or the BUCK/BOOST circuit 320 is determined based on the operating priorities of the AC/DC conversion circuit 110, the DC/DC conversion circuit 120, and the BUCK/BOOST circuit 320, and the bus voltage on the DC bus 101. Therefore, the conversion power of the AC/DC conversion circuit 110, the DC/DC conversion circuit 120, or the BUCK/BOOST circuit 320 is equal to the output power of the first photovoltaic module 240, thereby avoiding the problem of a damaged device caused by overloading when the bus voltage of the DC bus 101 is low.

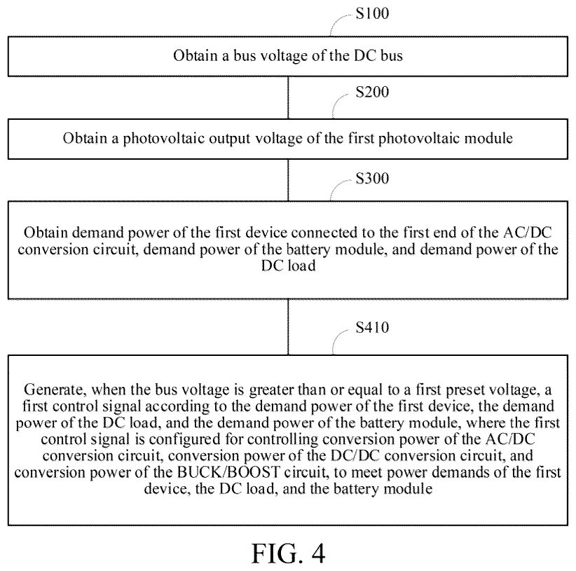

In an embodiment, as shown in FIG. 4, in step S400, the controlling operating states of the AC/DC conversion circuit 110, the DC/DC conversion circuit 120, the BOOST circuit 310, and the BUCK/BOOST circuit 320 respectively according to the demand power of the first device 210, the demand power of the battery module 220, the demand power of the DC load 230, and the bus voltage specifically includes step S410.

Step S410: Generate, when the bus voltage is greater than or equal to a first preset voltage, a first control signal according to the demand power of the first device 210, the demand power of the DC load 230, and the demand power of the battery module 220, where the first control signal is configured for controlling the conversion power of the AC/DC conversion circuit 110, the conversion power of the DC/DC conversion circuit 120, and the conversion power of the BUCK/BOOST circuit 320, to meet power demands of the first device 210, the DC load 230, and the battery module 220.

In this embodiment, when the first device 210 is an alternating current power consuming device, the first photovoltaic module 240 is used as a unique power supply power source to supply power to the DC bus 101. When the bus voltage on the DC bus 101 is greater than or equal to the first preset voltage, the sum of the demand power of the first device 210, the demand power of the battery module 220, and the demand power of the DC load 230 is equal to or less than the output power of the first photovoltaic module 240, and the first photovoltaic module 240 can meet the demand power of the first device 210, the demand power of the battery module 220, and the demand power of the DC load 230 simultaneously. The first control signal is generated according to the demand power of the first device 210, the demand power of the DC load 230, and the demand power of the battery module 220, and the first control signal is configured for controlling the conversion power of the AC/DC conversion circuit 110, the conversion power of the DC/DC conversion circuit 120, and the conversion power of the BUCK/BOOST circuit 320, to meet the power demands of the first device 210, the DC load 230, and the battery module 220.

For example, in an embodiment, the first preset voltage is 550 V. The bus voltage of the DC bus 101 is equivalent to a voltage outputted by the BOOST circuit 310, and when the bus voltage of the DC bus 101 is greater than 550 V, the AC/DC conversion circuit 110 operates normally to output an alternating current to the first device 210. In this case, the DC/DC conversion circuit 120 operates normally to charge the battery module 220, and the BUCK/BOOST circuit 320 also operates normally to output a direct current to a charging pile.

It should be noted that, in a specific application environment of this operating condition, related control may be performed according to an access status of the power supply circuit. When the DC load 230 is charging pile and the first device 210 is an alternating current device, the conduction or non-conduction of switching devices in the branch where the charging station and the AC device are connected is determined based on the connection status, where the switch device may be a relay.

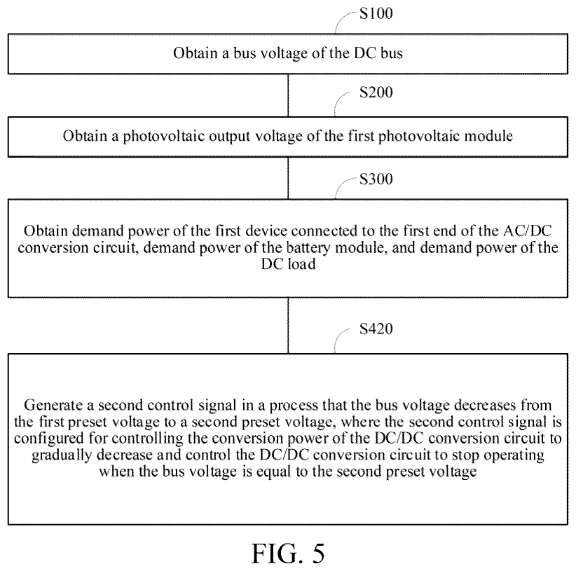

In an embodiment, as shown in FIG. 5, the control method in this embodiment further includes step S420.

Step S420: Generate a second control signal in a process that the bus voltage decreases from the first preset voltage to a second preset voltage, where the second control signal is configured for controlling the conversion power of the DC/DC conversion circuit 120 to gradually decrease and controlling the DC/DC conversion circuit 120 to stop operating when the bus voltage is equal to the second preset voltage.

In this embodiment, if the bus voltage on the DC bus 101 decreases from the first preset voltage to the second preset voltage, in this case, the sum of the demand power of the first device 210, the demand power of the battery module 220, and the demand power of the DC load 230 is greater than the output power of the first photovoltaic module 240. Since a priority of charging the battery module 220 is lower than a priority of supplying power to the DC load 230 and supplying power to the first device 210, in this case, the second control signal is sent to the DC/DC conversion circuit 120, and the second control signal controls the conversion power of the DC/DC conversion circuit 120 to gradually decrease. When the bus voltage is equal to the second preset voltage, the DC/DC conversion circuit 120 is controlled to stop operating, to stop the DC/DC conversion circuit from charging the battery module 220.

In an embodiment, the second preset voltage may be 500 V. When the bus voltage of the DC bus 101 is greater than 500 V and less than 550 V, the conversion power of the DC/DC conversion circuit 120 is controlled to gradually decrease, and the BUCK/BOOST circuit 320 is controlled to operate normally. Specifically, when it is determined that the battery module 220 needs to be charged, in a process that the photovoltaic output voltage of the first photovoltaic module 240 gradually decreases, the DC/DC conversion circuit 120 is controlled to perform voltage conversion according to the photovoltaic output voltage, to charge the battery module 220 until the bus voltage decreases to 500 V. Controlling the DC/DC conversion circuit 120 to perform voltage conversion according to the photovoltaic output voltage includes: controlling switching frequencies of switches in the DC/DC conversion circuit 120, and reducing duty cycles of the switches to reduce the conversion power of the DC/DC conversion circuit 120.

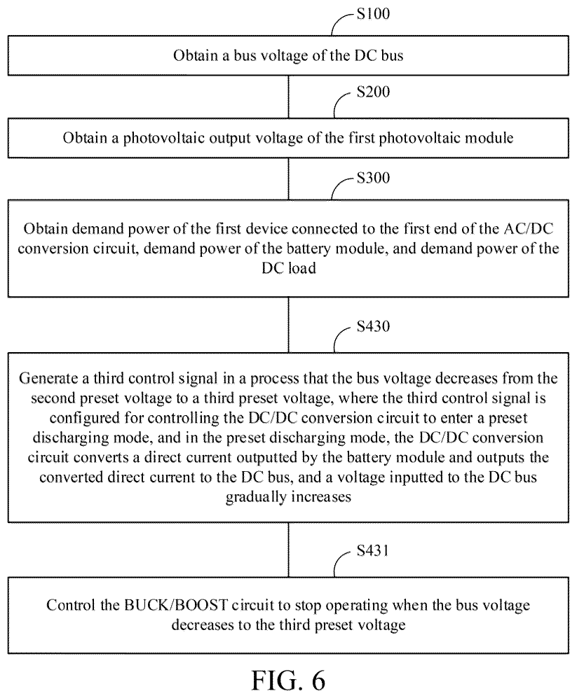

In an embodiment, as shown in FIG. 6, the control method in this embodiment further includes step S430 and step S431.

Step S430: Generate a third control signal in a process that the bus voltage decreases from the second preset voltage to a third preset voltage, where the third control signal is configured for controlling the DC/DC conversion circuit 120 to enter a preset discharging mode, and in the preset discharging mode, the DC/DC conversion circuit 120 converts a direct current outputted by the battery module 220 and outputs the converted direct current to the DC bus 101, and a voltage inputted to the DC bus 101 gradually increases.

In this embodiment, when the bus voltage continues to decrease from the second preset voltage, it indicates that the output power of the first photovoltaic module 240 continues to decrease in this case. To meet the demand power of the first device 210 and the demand power of the DC load 230, the third control signal is sent to the DC/DC conversion circuit 120, the third control signal controls the DC/DC conversion circuit 120 to enter the preset discharging mode, and the DC/DC conversion circuit 120 converts the direct current outputted by the battery module 220 and outputs the converted direct current to the DC bus 101. To slow down a decrease in the bus voltage or increase the bus voltage, the conversion power of the DC/DC conversion circuit 120 also gradually increases, and a voltage outputted by the DC/DC conversion circuit 120 to the DC bus 101 gradually increases.

Step S431: When the bus voltage decreases to the third preset voltage, control the BUCK/BOOST circuit 320 to stop operating.

In this embodiment, when the bus voltage starts to decrease from the second preset voltage, the DC/DC conversion circuit 120 enters the preset discharging mode. In the preset discharging mode, the DC/DC conversion circuit 120 converts the direct current outputted by the battery module 220 and outputs the converted direct current to the DC bus 101. To slow down a decrease in the bus voltage or increase the bus voltage, the voltage inputted by the DC/DC conversion circuit 120 to the DC bus 101 gradually increases. When the bus voltage of the DC bus 101 decreases to the third preset voltage, since the priority of the first device 210 is higher than the priority of the DC load 230, to meet the demand power of the first device 210, in this case, the BUCK/BOOST circuit 320 is controlled to stop operating.

In an embodiment, the third preset voltage may be 450 V. When the bus voltage of the DC bus 101 is greater than 450 V and less than 500 V, it indicates that the photovoltaic output voltage of the first photovoltaic module 240 cannot meet the demand power of the first device 210 and the demand power of the DC load 230. In this case, the BUCK/BOOST circuit 320 is controlled to stop operating, and a switch of an output end of the BUCK/BOOST circuit 320 is turned off. In this case, if the output end of the BUCK/BOOST circuit 320 is connected to the DC load 230 like a direct current charging pile, the battery module 220 is controlled to start to gradually discharge. Controlling the battery module 220 to gradually discharge indicates that a discharge voltage of the battery module 220 gradually increases, to meet a voltage demand of the DC bus 101. When the bus voltage of the DC bus 101 decreases to 450 V, the BUCK/BOOST circuit 320 is turned off, and the DC bus 101 stops supplying power to the DC load 230.

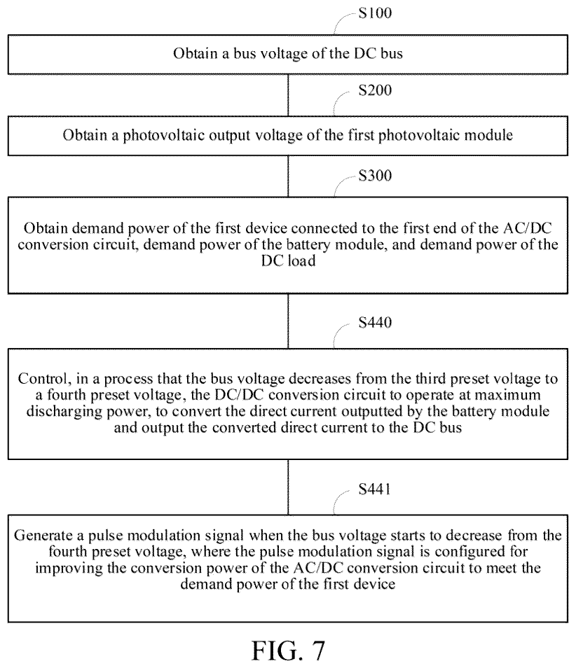

In an embodiment, as shown in FIG. 7, the control method in this embodiment further includes step S440 and step S441.

Step S440: Control, in a process that the bus voltage decreases from the third preset voltage to a fourth preset voltage, the DC/DC conversion circuit 120 to operate at maximum discharging power, to convert the direct current outputted by the battery module 220 and output the converted direct current to the DC bus 101.

In this embodiment, if the output power of the first photovoltaic module 240 continues to decrease, the bus voltage on the DC bus 101 continues to decrease in this case. In a process that the bus voltage decreases from the third preset voltage, the BUCK/BOOST circuit 320 has stopped operating. To slow down a decrease in the bus voltage or increase the bus voltage, the DC/DC conversion circuit 120 operates at the maximum discharging power, to convert the direct current outputted by the battery module 220 and output the converted direct current to the DC bus 101.

Step S441: When the bus voltage starts to decrease from the fourth preset voltage, generate a pulse modulation signal, where the pulse modulation signal is configured for improving the conversion power of the AC/DC conversion circuit 110 to meet the demand power of the first device 210.

In this embodiment, if the output power of the first photovoltaic module 240 continues to decrease, in this case, the bus voltage on the DC bus 101 decreases to the fourth preset voltage and continues to decrease from the fourth preset voltage. By improving duty cycles of switches in the AC/DC conversion circuit 110, the conversion efficiency is improved, and an objective of meeting the demand power of the first device 210 is achieved.

In an embodiment, the fourth preset voltage may be 400 V. When the bus voltage of the DC bus 101 is greater than 400 V and less than 450 V, the DC/DC conversion circuit 120 is controlled to discharge at full power. When the DC/DC conversion circuit 120 discharges at full power, the DC/DC conversion circuit 120 converts a voltage of the battery module 220 and outputs the converted voltage to the DC bus 101. The AC/DC conversion circuit 110 then converts a direct current on the DC bus 101 into an alternating current to ensure the power supplied to the first device 210.

When the bus voltage of the DC bus 101 is greater than 360 V and less than 400 V, the duty cycles of the switches in the AC/DC conversion circuit 110 are improved, so that the conversion power of the AC/DC conversion circuit 110 is improved, to meet the power demand of the first device 210.

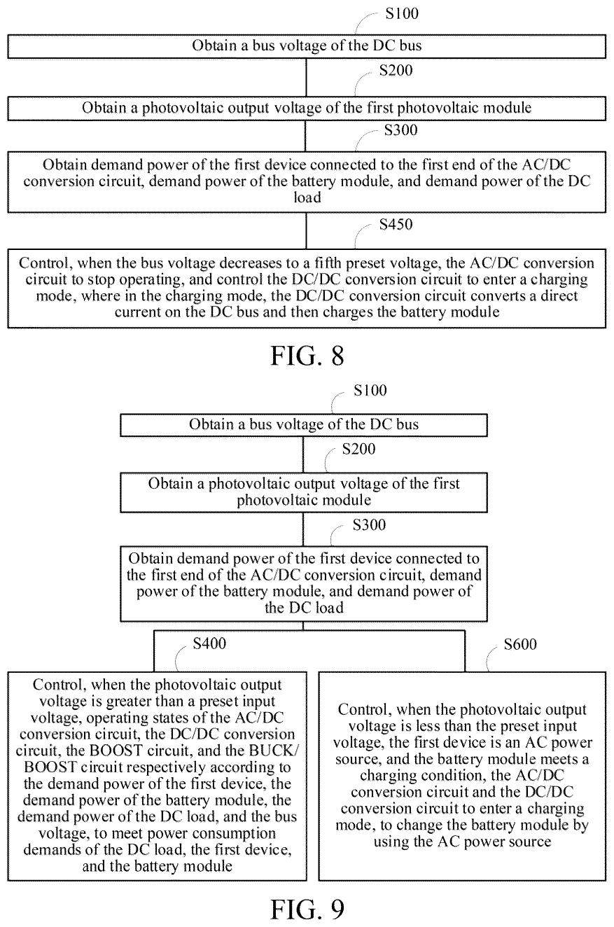

In an embodiment, as shown in FIG. 8, the control method in this embodiment further includes step S450.

Step S450: Control, when the bus voltage decreases to a fifth preset voltage, the AC/DC conversion circuit 110 to stop operating, and control the DC/DC conversion circuit 120 to enter a charging mode, where in the charging mode, the DC/DC conversion circuit 120 converts the direct current on the DC bus 101 and charges the battery module 220.

In this embodiment, if the output power of the first photovoltaic module 240 continues to decrease, when the battery module 220 discharges at maximum power, the bus voltage on the DC bus 101 decreases from the fourth preset voltage to the fifth preset voltage, which indicates that a discharge output of the battery module 220 can no longer meet the demand power of the first device 210, and the state of charge of the battery module 220 is nearly exhausted. In this case, the AC/DC conversion circuit 110 stops operating, the DC/DC conversion circuit 120 enters the charging mode, and in the charging mode, the DC/DC conversion circuit 120 converts the direct current on the DC bus 101 and charges the battery module 220.

In an embodiment, the fifth preset voltage may be 360 V. When the bus voltage of the DC bus 101 is less than or equal to 360 V, the AC/DC conversion circuit stops operating, and related relays in the power supply circuit are turned off, to stop the power supplied to the first device 210 and the DC load 230. In this case, the operating state of the DC/DC conversion circuit 120 is controlled to be switched to the charging mode, so that the DC/DC conversion circuit 120 performs voltage conversion on the direct current on the DC bus 101 and charges the battery module 220.

In an embodiment, as shown in FIG. 9, the control method further includes step S600.

Step S600: Control, when the photovoltaic output voltage is less than the preset input voltage, the first device 210 is an AC power source, and the battery module 220 meets a charging condition, the AC/DC conversion circuit 110 and the DC/DC conversion circuit 120 to enter a charging mode, to change the battery module 220 by using the AC power source.

In this embodiment, the first device 210 is an AC power source. The first photovoltaic module 240 has small output power under weak illumination. In this case, the photovoltaic output voltage of the first photovoltaic module 240 is less than the preset input voltage. In this case, the voltage of the battery module 220 is less than a preset value, which indicates that the state of charge of the battery module 220 is low and the battery module 220 meets a charging condition. That is, the AC/DC conversion circuit 110 and the DC/DC conversion circuit 120 are controlled to enter the charging mode. In the charging mode, the AC/DC conversion circuit 110 converts an alternating current provided by the AC power source into a direct current and outputs the direct current to the DC bus 101, and the DC/DC conversion circuit 120 performs voltage conversion on the direct current on the DC bus 101 and charges the battery module 220, so that the AC power source is used to charge the battery module 220.

In an embodiment, the preset input voltage is 0 V, and the photovoltaic output voltage of the first photovoltaic module 240 being less than the preset input voltage may indicate that the first photovoltaic module 240 almost has no voltage output. In this case, an environment in which the first photovoltaic module 240 is located is night, the AC power source charges the battery module 220.

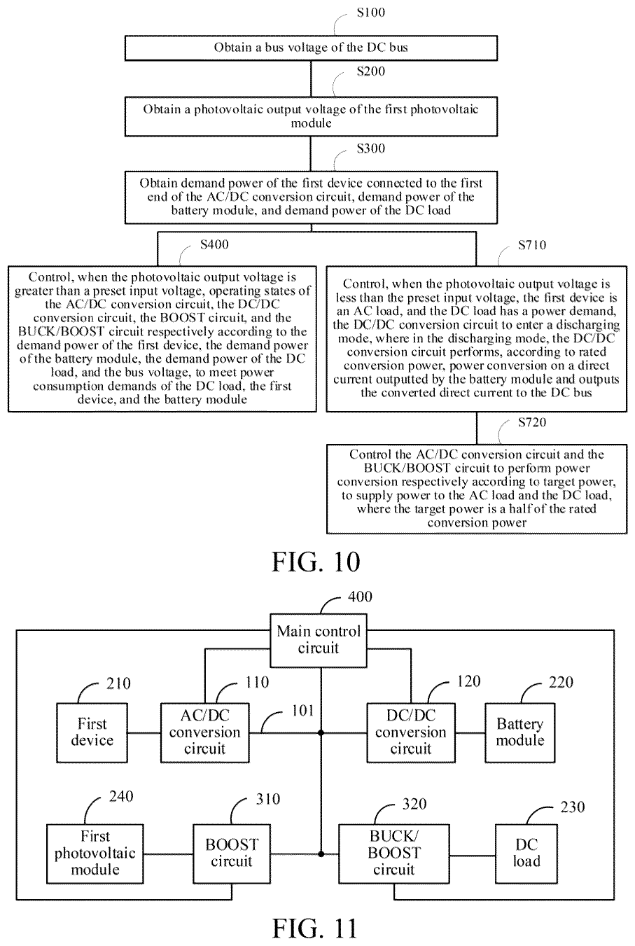

In an embodiment, as shown in FIG. 10, the control method further includes step S710 and step S720.

Step S710: Control, when the photovoltaic output voltage is less than the preset input voltage, the first device 210 is an AC load, and the DC load 230 has a power demand, the DC/DC conversion circuit 120 to enter a discharging mode, where in the discharging mode, the DC/DC conversion circuit 120 performs, according to rated conversion power, power conversion on a direct current outputted by the battery module 220 and outputs the converted direct current to the DC bus 101.

In this embodiment, the first device 210 is an AC load. The first photovoltaic module 240 has small output power if the first photovoltaic module is located in an environment with weak illumination. In this case, the photovoltaic output voltage of the first photovoltaic module 240 is less than the preset input voltage. If the DC load 230 has a power demand, the DC/DC conversion circuit 120 is controlled to enter the discharging mode, and the DC/DC conversion circuit 120 performs, according to the rated conversion power, power conversion on the direct current outputted by the battery module 220 and outputs the converted direct current to the DC bus 101. The BUCK/BOOST circuit 320 performs voltage conversion on the direct current on the DC bus 101 and outputs the converted direct current to the DC load 230, to meet the demand power of the DC load 230.

Step S720: Control the AC/DC conversion circuit 110 and the BUCK/BOOST circuit 320 to perform power conversion respectively according to target power, to supply power to the AC load and the DC load 230.

In this embodiment, the DC/DC conversion circuit 120 performs, according to the rated conversion power, power conversion on the direct current outputted by the battery module 220 and outputs the converted direct current to the DC bus 101. The AC/DC conversion circuit 110 converts the direct current on the DC bus 101 according to the target power into an alternating current and outputs the alternating current to the AC load. The BUCK/BOOST circuit 320 converts the direct current on the DC bus 101 according to the target power and outputs the converted direct current to the DC load 230, where the target power is a half of the rated conversion power, to meet the demand power of the AC load and the demand power of the DC load 230.

An embodiment of this application further provides a power supply circuit. As shown in FIG. 11, the power supply circuit in this embodiment includes: an AC/DC conversion circuit 110, a DC/DC conversion circuit 120, a BOOST circuit 310, a BUCK/BOOST circuit 320, and a main control circuit 400.

Specifically, a first end of the AC/DC conversion circuit 110 is configured to connect to a first device 210, and a second end of the AC/DC conversion circuit 110 is connected to a first end of the DC/DC conversion circuit 120 through a DC bus 101. A second end of the DC/DC conversion circuit 120 is configured to connect to a battery module 220. An input end of the BOOST circuit 310 is configured to connect to a first photovoltaic panel, an output end of the BOOST circuit 310 and a first end of the BUCK/BOOST circuit 320 are commonly connected to the DC bus 101, and a second end of the BUCK/BOOST circuit 320 is configured to connect to a DC load 230. The main control circuit 400 is respectively connected to the AC/DC conversion circuit 110, the DC/DC conversion circuit 120, the BOOST circuit 310, the BUCK/BOOST circuit 320, and the DC bus 101.

In this embodiment, the main control circuit 400 is configured to perform the control method according to any one of the foregoing embodiments.

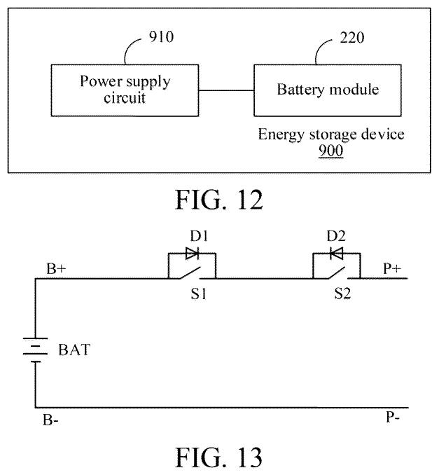

An embodiment of this application provides an energy storage device. As shown in FIG. 12, the energy storage device 900 includes a battery module 220 and a power supply circuit 910, and the power supply circuit 910 may be the power supply circuit according to any one of the foregoing embodiments.

In an embodiment, the energy storage device 900 may further include a grid-connected interface circuit, and the energy storage device may be configured to connect to another energy storage device through the grid-connected interface circuit.

In an embodiment, as shown in FIG. 13, the battery module 220 includes a first switch S1, a second switch S2, a first diode D1, a second diode D2, and a battery assembly BAT.

Specifically, the DC/DC conversion circuit 120 is connected to the battery module 220 through a first positive terminal P+ and a first negative terminal P−. The first switch S1, the second switch S2, the first diode D1, and the second diode D2 form a switch circuit in the battery module 220. The switch circuit is connected to a power source management system BMS in the battery module 220. A first end of the first switch S1 and an anode of the first diode D1 are commonly connected to a positive electrode B+ of the battery assembly BAT, a second end of the first switch S1, a cathode of the first diode D1, a cathode of the second diode D2, and a first end of the second switch S2 are commonly connected, an anode of the second diode D2 and a second end of the second switch S2 are commonly connected to the first positive terminal P+, and a negative electrode B− of the battery assembly BAT is connected to the first negative terminal P−.

In this embodiment, the main control circuit 400 may control turn-on/turn-off states of the first switch S1 and the second switch S2 to control switching of the battery assembly BAT between charging, discharging, and standby states. For example, when receiving a first indication signal sent by the main control circuit 400, the BMS controls the first switch S1 to be turned off, controls the second switch S2 to be turned on, and controls the battery assembly BAT to change from a charging state to a discharging state. When receiving a second indication signal, the BMS controls the first switch S1 to be turned on, controls the second switch S2 to be turned off, and controls the battery assembly BAT to change from the discharging state to the charging state. When receiving a standby signal, the BMS controls the first switch S1 and the second switch S2 to be turned off. In this case, the battery assembly BAT is in a standby state. It should be noted that, when the first switch S1 is turned off and the second switch S2 is turned on, the battery assembly BAT is in a pre-discharging state, and in the pre-discharging state, electric energy of the battery assembly is outputted through the first diode D1 and the second switch S2. When the first switch S1 is turned on, the electric energy of the battery assembly BAT is outputted through the first switch S1 and the second switch S2. In this case, the battery assembly BAT is in a fully discharged state. When the first switch S1 is turned on and the second switch S2 is turned off, the battery assembly BAT is in a pre-charging state, and in the pre-charging state, electric energy provided by the outside is inputted through the second diode D2 and the first switch S1. When the second switch S2 is turned on, the electric energy provided by the outside is inputted through the first switch S1 and the second switch S2. In this case, the battery assembly BAT is in a fully charged state.

In an embodiment, the first switch S1 and the second switch S2 may be switch devices such as relays or MOS transistors.

In the foregoing embodiments, the descriptions of the embodiments have respective focuses. For a part that is not described in detail in an embodiment, reference may be made to related descriptions in other embodiments.

The foregoing embodiments are merely used for describing the technical solutions of this application, but are not intended to limit this application. Although this application is described in detail with reference to the foregoing embodiments, it should be understood that a person of ordinary skill in the art may still make modifications to the technical solutions described in the foregoing embodiments or make equivalent replacements to some technical features thereof, and these modifications or replacements will not cause the essence of corresponding technical solutions to depart from the spirit and the scope of the technical solutions in the embodiments of this application, and shall all fall within the protection scope of this application.

What is claimed is:

1. A control method of a power supply circuit, wherein the power supply circuit comprises: an AC/DC conversion circuit, a DC/DC conversion circuit, a BOOST circuit, and a BUCK/BOOST circuit, wherein a first end of the AC/DC conversion circuit is configured to connect to a first device, a second end of the AC/DC conversion circuit is connected to a first end of the DC/DC conversion circuit through a DC bus, a second end of the DC/DC conversion circuit is configured to connect to a battery module, an input end of the BOOST circuit is configured to connect to a first photovoltaic module, an output end of the BOOST circuit and a first end of the BUCK/BOOST circuit are commonly connected to the DC bus, and a second end of the BUCK/BOOST circuit is configured to connect to a DC load; and the control method of a power supply circuit comprises:
obtaining a bus voltage of the DC bus;
obtaining a photovoltaic output voltage of the first photovoltaic module;
obtaining demand power of the first device, demand power of the battery module, and demand power of the DC load; and
controlling, when the photovoltaic output voltage is greater than a preset input voltage, operating states of the AC/DC conversion circuit, the DC/DC conversion circuit, the BOOST circuit, and the BUCK/BOOST circuit respectively according to the demand power of the first device, the demand power of the battery module, the demand power of the DC load, and the bus voltage, to meet power consumption demands of the DC load, the first device, and the battery module.

2. The control method of a power supply circuit according to claim 1, wherein the control method further comprises:
obtaining priorities of the first device, the battery module, and the DC load, and determining operating priorities of the AC/DC conversion circuit, the DC/DC conversion circuit, and the BUCK/BOOST circuit according to the priorities of the first device, the battery module, and the DC load; and
controlling the operating states of the AC/DC conversion circuit, the DC/DC conversion circuit, or the BUCK/BOOST circuit according to the operating priorities and the bus voltage.

3. The control method of a power supply circuit according to claim 1, wherein the controlling operating states of the AC/DC conversion circuit, the DC/DC conversion circuit, the BOOST circuit, and the BUCK/BOOST circuit respectively according to the demand power of the first device, the demand power of the battery module, the demand power of the DC load, and the bus voltage comprises:
generating, when the bus voltage is greater than or equal to a first preset voltage, a first control signal according to the demand power of the first device, the demand power of the DC load, and the demand power of the battery module, wherein the first control signal is configured for controlling conversion power of the AC/DC conversion circuit, conversion power of the DC/DC conversion circuit, and conversion power of the BUCK/BOOST circuit, to meet power demands of the first device, the DC load, and the battery module.

4. The control method of a power supply circuit according to claim 3, wherein the control method further comprises:
generating a second control signal in a process that the bus voltage decreases from the first preset voltage to a second preset voltage, wherein the second control signal is configured for controlling the conversion power of the DC/DC conversion circuit to gradually decrease and controlling the DC/DC conversion circuit to stop operating when the bus voltage is equal to the second preset voltage.

5. The control method of a power supply circuit according to claim 4, wherein the control method further comprises:
generating a third control signal in a process that the bus voltage decreases from the second preset voltage to a third preset voltage, wherein the third control signal is configured for controlling the DC/DC conversion circuit to enter a preset discharging mode, and in the preset discharging mode, the DC/DC conversion circuit converts a direct current outputted by the battery module and outputs the converted direct current to the DC bus, and a voltage inputted to the DC bus gradually increases; and
controlling the BUCK/BOOST circuit to stop operating when the bus voltage decreases to the third preset voltage.

6. The control method of a power supply circuit according to claim 5, wherein the control method further comprises:
controlling, in a process that the bus voltage decreases from the third preset voltage to a fourth preset voltage, the DC/DC conversion circuit to operate at maximum discharging power, to convert the direct current outputted by the battery module and output the converted direct current to the DC bus; and
generating a pulse modulation signal when the bus voltage starts to decrease from the fourth preset voltage, wherein the pulse modulation signal is configured for improving the conversion power of the AC/DC conversion circuit to meet the demand power of the first device.

7. The control method of a power supply circuit according to claim 6, wherein the control method further comprises:
controlling, when the bus voltage decreases to a fifth preset voltage, the AC/DC conversion circuit to stop operating and controlling the DC/DC conversion circuit to enter a charging mode, wherein in the charging mode, the DC/DC conversion circuit converts a direct current on the DC bus and then charges the battery module.

8. The control method of a power supply circuit according to claim 1, wherein the control method further comprises:
controlling, when the photovoltaic output voltage is less than the preset input voltage, the first device is an AC power source, and the battery module meets a charging condition, the AC/DC conversion circuit and the DC/DC conversion circuit to enter a charging mode, to change the battery module by using the AC power source.

9. The control method of a power supply circuit according to claim 1, wherein the control method further comprises:
controlling, when the photovoltaic output voltage is less than the preset input voltage, the first device is an AC load, and the DC load has a power demand, the DC/DC conversion circuit to enter a discharging mode, wherein in the discharging mode, the DC/DC conversion circuit performs, according to rated conversion power, power conversion on a direct current outputted by the battery module and outputs the converted direct current to the DC bus; and
controlling the AC/DC conversion circuit and the BUCK/BOOST circuit to perform power conversion respectively according to target power, to supply power to the AC load and the DC load, wherein the target power is a half of the rated conversion power.

10. A power supply circuit, comprising: an AC/DC conversion circuit, a DC/DC conversion circuit, a BOOST circuit, a BUCK/BOOST circuit, and a main control circuit, wherein a first end of the AC/DC conversion circuit is configured to connect to a first device, a second end of the AC/DC conversion circuit is connected to a first end of the DC/DC conversion circuit through a DC bus, a second end of the DC/DC conversion circuit is configured to connect to a battery module, an input end of the BOOST circuit is configured to connect to a first photovoltaic panel, an output end of the BOOST circuit and a first end of the BUCK/BOOST circuit are commonly connected to the DC bus, a second end of the BUCK/BOOST circuit is configured to connect to a DC load, and the main control circuit is respectively connected to the AC/DC conversion circuit, the DC/DC conversion circuit, the BOOST circuit, the BUCK/BOOST circuit, and the DC bus; and
the main control circuit is configured to perform the control method according to claim 1.

11. An energy storage device, comprising a battery module, an AC/DC conversion circuit, a DC/DC conversion circuit, a BOOST circuit, a BUCK/BOOST circuit, and a main control circuit, wherein a first end of the AC/DC conversion circuit is configured to connect to a first device, a second end of the AC/DC conversion circuit is connected to a first end of the DC/DC conversion circuit through a DC bus, a second end of the DC/DC conversion circuit is configured to connect to a battery module, an input end of the BOOST circuit is configured to connect to a first photovoltaic panel, an output end of the BOOST circuit and a first end of the BUCK/BOOST circuit are commonly connected to the DC bus, a second end of the BUCK/BOOST circuit is configured to connect to a DC load, and the main control circuit is respectively connected to the AC/DC conversion circuit, the DC/DC conversion circuit, the BOOST circuit, the BUCK/BOOST circuit, and the DC bus; and
the main control circuit is configured to perform the control method according to claim 1.
